(19) United States
(12) Patent Application Publication
(10) Pub. No.: US 2010/0244735 A1
(43) Pub. Date: Sep. 30, 2010

(54) Lighting Device Supplying Temporally Appropriate Light

(75) Inventor: Roger F. Buelow, II, Gates Mills, OH (US)

Correspondence Address: BRUZGA & ASSOCIATES, 11 BROADWAY, SUITE 715, NEW YORK, NY, 10004, US

(73) Assignee: Energy Focus, Inc., Solon, OH (US)

(21) Appl. No.: 12/748,298

(22) Filed: Mar. 26, 2010

Related U.S. Application Data
(60) Provisional application No. 61/163,617, filed on Mar. 26, 2009.

(51) Int. Cl. H05B 37/02

(52) U.S. Cl. 315/294; 315/320; 315/360

(57) ABSTRACT

A lighting device operable to supply temporally appropriate light to a user comprises a light socket adapter interposed between a primary socket and a first type of lamp. The primary socket is connected to a switchable supply of electrical power. A first type of lamp includes wavelengths below 530 nm that are suppressive of melatonin production in a user viewing the light. There is a second type of lamp that supplies light substantially all above 530 nm so as to avoid suppressing melatonin production in a user viewing the light. The light socket adapter has at least one mode of operation in which automatic means causes the first and second types of lamp to be exclusively operable during respective predetermined periods of time.

### FIELD OF THE INVENTION

The present invention relates to a lighting device that supplies temporally appropriate light to a user. More particularly, such lighting device incorporates a lamp that suppresses melatonin production in a user and a lamp that avoids the suppression of melatonin in the user.

### BACKGROUND OF THE INVENTION

It is known that light at wavelengths below about 530 nanometers (nm) causes suppression in melatonin production in a user. Such light can be disruptive to the ability for a user to quickly return to sleep after having awoken for any reason.

There are nightlights on the market that emit light only above 530 nm, which are designed to prevent the suppression of melatonin in a user. However, such nightlights require their own power source, which may typically be an electrical outlet located on a wall usually close to the floor. It would be desirable to provide a lighting device that can be more versatile that such a single-purpose nightlight. It would further be desirable to provide lighting device that can be inserted into existing wall-, ceiling- or fixture-mounted light sockets, and also provide the normal (e.g., daytime) lighting expected from such light sockets.

### BRIEF SUMMARY OF THE INVENTION

A preferred embodiment provides a lighting device operable to supply temporally appropriate light to a user. The device comprises a light socket adapter for interposing between a primary socket and a first type of lamp. The primary socket is connected to a supply of electrical power when an associated power switch is in a power-on state and is disconnected from the supply of electrical power when the associated power switch is in a power-off state. The light socket adapter includes a body portion. At least one of a second type of lamp is mounted on the body portion. The body portion has a first type of socket for receiving and supplying power to the first type of lamp. The first type of lamp supplies light that includes wavelengths below 530 nm that are suppressive of melatonin production in a user viewing the light, and the second type of lamp supplies light that is substantially all above 530 nm so as to avoid suppressing melatonin production in a user viewing the light. The light socket adapter has at least one mode of operation in which automatic means causes—
only the first type of lamp to be operable during predetermined periods of time when the user determines that melatonin-suppression will not adversely affect the user and only when the power switch is in a power-on state, and
only the second type of lamp to be operable during predetermined periods of time when avoidance of melatonin suppression is desired by the user and only when the power switch is in a power-on state.

The foregoing lighting device beneficially can be inserted in existing wall-, ceiling- or fixture-mounted light sockets, and provide the normally expected light in connection with such light sockets.

The foregoing lighting device beneficially can also use the existing power-switches for the existing wall-, ceiling- or fixture-mounted light sockets.

Further benefits and features of the invention will be appreciated from a review of the drawings in connection with the following description.

### BRIEF DESCRIPTION OF THE DRAWING

In the drawings, in which like reference numerals refer to like parts:

FIG. 1A is a side view of a lighting device and associated power supply circuit in accordance with the invention; and FIG. 1B is a top view of the lighting device of FIG. 1A taken at arrows 1B-1B in FIG. 1A, which omits the upper shown light bulb for simplicity.

FIG. 2 is a prior art graph of melatonin levels in a user versus time of day for a typical user.

FIG. 3 is a prior art graph of quantum efficiency of melatonin suppression versus wavelength of light provided to a user, and a prior art graph of photopic vision versus wavelength of light.

FIG. 4 is a block diagram of a typical electronic control circuit for operating lighting devices of the invention, such as that shown in FIG. 1.

FIG. 5A is a side view of another lighting device in accordance with the invention; and FIG. 5B is a top view of the lighting device of FIG. 5A taken at arrows 5B-5B in FIG. 5A, which omits the upper shown light bulb for simplicity.

FIGS. 6A and 6B are similar to FIGS. 5A and 5B, but show another lighting device in accordance with the invention, and further including light intensity versus minutes graphs.

FIG. 6C is a graph showing different time periods versus time.

FIGS. 7A and 7B are similar to FIGS. 5A and 5B, but show another lighting device in accordance with the invention.

FIGS. 8A and 8B are similar to FIGS. 5A and 5B, but show another lighting device in accordance with the invention.

FIGS. 9A and 9B are similar to FIGS. 5A and 5B, but show another lighting device in accordance with the invention.

FIG. 9C is a side view of a light source and associated fiberoptic light pipe.

FIGS. 10A and 10B are similar to FIGS. 5A and 5B, but show another lighting device in accordance with the invention.

FIGS. 11A and 11B are similar to FIGS. 5A and 5B, but show another lighting device in accordance with the invention.

FIGS. 12A and 12B are similar to FIGS. 5A and 5B, but show another lighting device in accordance with the invention.

FIGS. 13A and 13B are similar to FIGS. 5A and 5B, but show another lighting device in accordance with the invention.

FIGS. 14A and 14B are similar to FIGS. 5A and 5B, but show another lighting device in accordance with the invention.

FIGS. 15A and 15B are similar to FIGS. 5A and 5B, but show another lighting device in accordance with the invention.

FIG. 16A is a side view of a light socket adapter of a tubular configuration.

FIG. 16B is an end view of the light socket adapter of FIG. 16A taken at arrows 16B-16B in FIG. 16A.

FIG. 16C is a top view of a prior art fluorescent lamp in a fluorescent lamp fixture 210.

FIG. 16D is a top view of fluorescent lamp joined to the light socket adapter of FIG. 16A.

FIG. 17 is a front view of a user interface for inputting temporary offsets in time for transitioning between the first type of lamp being exclusively operable and the second type being exclusively operable.

### DETAILED DESCRIPTION OF THE INVENTION

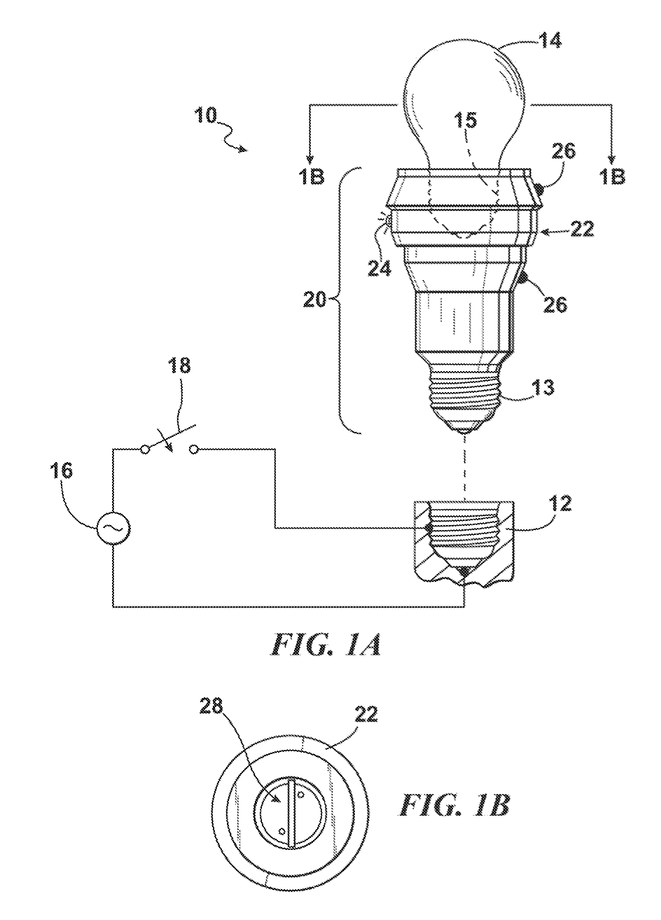

FIGS. 1A and 1B show a lighting device 10 for supplying temporarily appropriate light to a user. Lighting device 10 includes two different types of lamp, which have different effects on melatonin in a user, as will be explained below. In a preferred mode of operation, the different types of lamps can are operable at different times so as to be temporally appropriate to a user.

FIG. 1A shows lighting device 10 interposed between a primary lamp socket 12 and a first type of lamp 14, such as an incandescent lamp or compact fluorescent lamp having a so-called Edison screw base 15. The first type of lamp may alternatively comprise, by way of example, light emitting diodes (LEDs), cold cathode lamps, electroluminescent lamps, HID lamps or electrodeless sulfur lamps. Although the primary lamp socket 12 is shown as an Edison screw base, other screw base sockets, two-pin sockets, two-pin fluorescent sockets, one-pin fluorescent sockets and multi-pin compact fluorescent fixtures, among others, can be used. The lighting device 10 may have a first type socket 28 (FIG. 1A), for accommodating base 15 of the first type lamp 14, and a main adapter base 13 of different types. For instance, the main adapter base 13 may be a medium Edison screw base and the base 15 may accept instead a multi-pin compact fluorescent base. Where the first type of lamp 14 is a replaceable LED module, the first type socket for accommodating its base (comparable to base 15) would include a suitable heat conduction path for removing heat from the LED module.

Primary socket 12 is connected to a source of electrical (e.g., AC) power 16 when an associated switch 18 is in a power-on state, and is disconnected from the supply of electrical power 16 when the associated power switch is in a power-off state. Switch 18 may be a typical wall or lamp fixture switch for turning on a lighting device. Other switches (not shown) may be associated with switch 18, as for instance where two or more switches in different locations are used to control the on-off state of a lamp.

Lighting device 10 includes a light socket adapter 20 with a body portion 22. At least one of a second type of lamp (e.g., an LED) 24 is mounted on body portion 22. A light sensor 26 may be provided for sensing ambient light from the outdoors to determine whether the first type of lamp (e.g., 14) or the second type of lamp (e.g., 24) should be operated when a user turns switch 18 into a power-on (i.e., closed) state. For clarity of distinction between various of the second types of lamp (e.g., 24) and light sensors 26 shown herein, the following convention is used: The second types of lamps are shown with small rectangles inside a curved cover and, wherever practical, with light rays (unnumbered) emanating therefrom, although the second type of lamp does not always provide light when the inventive light socket adapter is energized; and the light sensors 26 are shown as all black, although they are typically not colored as such.

FIG. 1B (and FIG. 1A) shows a first type of light socket 28 of the so-called Edison-base type for receiving a first type of lamp 14. An Edison-base socket is merely exemplary, since any other type of light socket can be used to accommodate other styles of a first type of lamp.

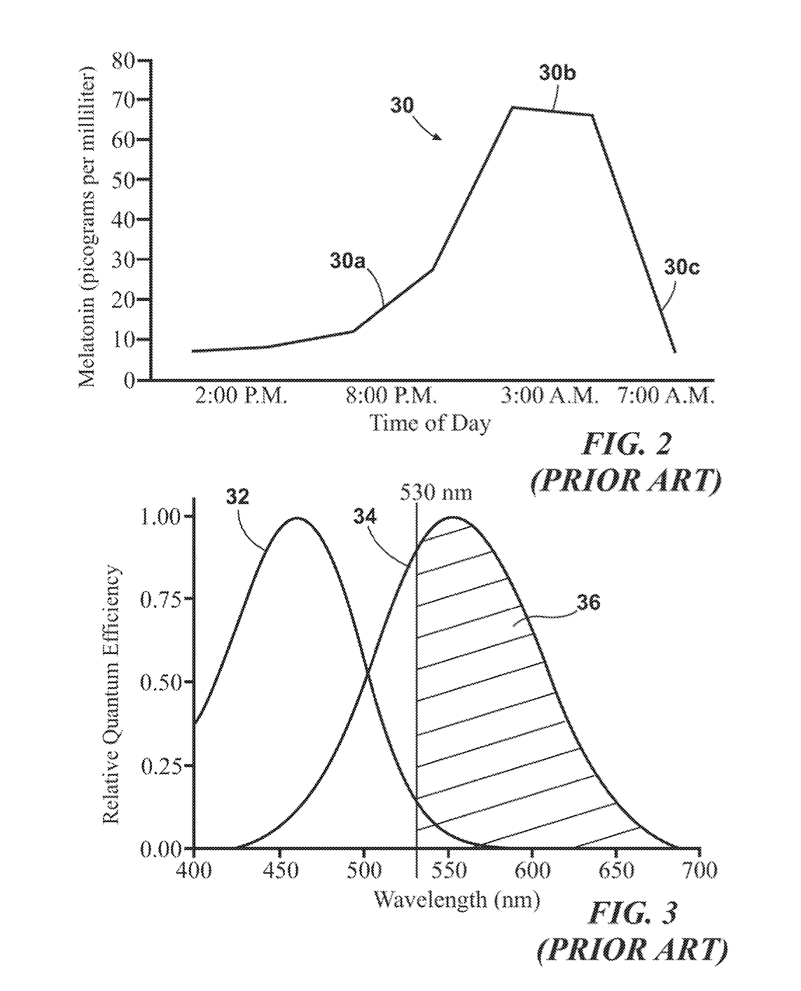

The nomenclature “first type” of lamp and “second type” of lamp will now be explained in connection with the graphs of FIGS. 2 and 3. FIG. 2 shows a prior art graph of melatonin level in a user versus time of day for a typical user who is awake during daytime hours and who sleeps during nighttime hours. Near the time indicated by 30a, the user's pineal gland begins producing melatonin in the evening. Near the time indicated by 30b, melatonin levels peak in the middle of the night. Near the time indicated by 30c, melatonin levels decline to low daytime levels.

### “First Type” of Lamp and “Second Type” of Lamp

FIG. 3 shows a graph 32 indicating relative quantum efficiency of suppression of melatonin versus wavelength of light. As can be appreciated, melatonin suppression occurs in a user viewing light below about 530 nanometers (nm). This is because the intrinsically photosensitive retinal ganglion cells of users are preferentially sensitive to light in the range of 420-460 nm (i.e., blue light), and when exposed to such light the user's body interprets this as the day having started and ceases the sleep cycle. In FIG. 2, such occurrence would typically be at the time indicated by 30c. On the other hand, the photosensitive retinal ganglion cells of users are barely sensitive to light above 530 nm, which is not suppressive of melatonin production. Thus, graph 34 of FIG. 3 shows typical photopic vision being facilitated by wavelengths of light in excess of about 530 nm while not being significantly suppressive of melatonin production. The cross-hatched area 36 in FIG. 3 indicates the foregoing type of light, which is referred to herein as light from a “second type” of lamp. The “second type” of lamp, as used herein, connotes one or a plurality of lamps conforming to the cross-hatched area 36 of FIG. 3, for instance. The “first type” of lamp, as used herein connotes one or a plurality of lamps supplying light that may include melatonin-suppressing wavelengths below 530 nm. The first type of lamp typically includes incandescent or gas discharge lamps used for home or office lighting.

By avoiding suppression of melatonin with the second type of lamp during typical sleep times, the circadian rhythms of a user of the second type of lamp are minimally, if at all, affected. This is believed to result in short, medium and long term wellness effects, including possible abatement of certain types of cancer, although the experimental data of the prior art, although substantial may not be considered conclusive to all observers. In the short term, avoiding suppression of melatonin production in a user when the user desires to quickly resume sleep can assist in the user getting a good night's sleep and its associated benefits. In the medium term, sleep “credit” rather than sleep “debt” can be established. In the long term, certain types of cancer might be in some respected abated.

Returning to FIG. 1A, second type of lamp 24 provides light that is substantially all above 530 nm so as to avoid suppressing melatonin production in a user. By “substantially all” the light being above 530 nm is meant herein that any light below 530 nm produced by the second type of lamp below 530 nm is sufficiently negligible so as to avoid creating significant melatonin suppression.

### Operation in Response to Sensed Ambient Light

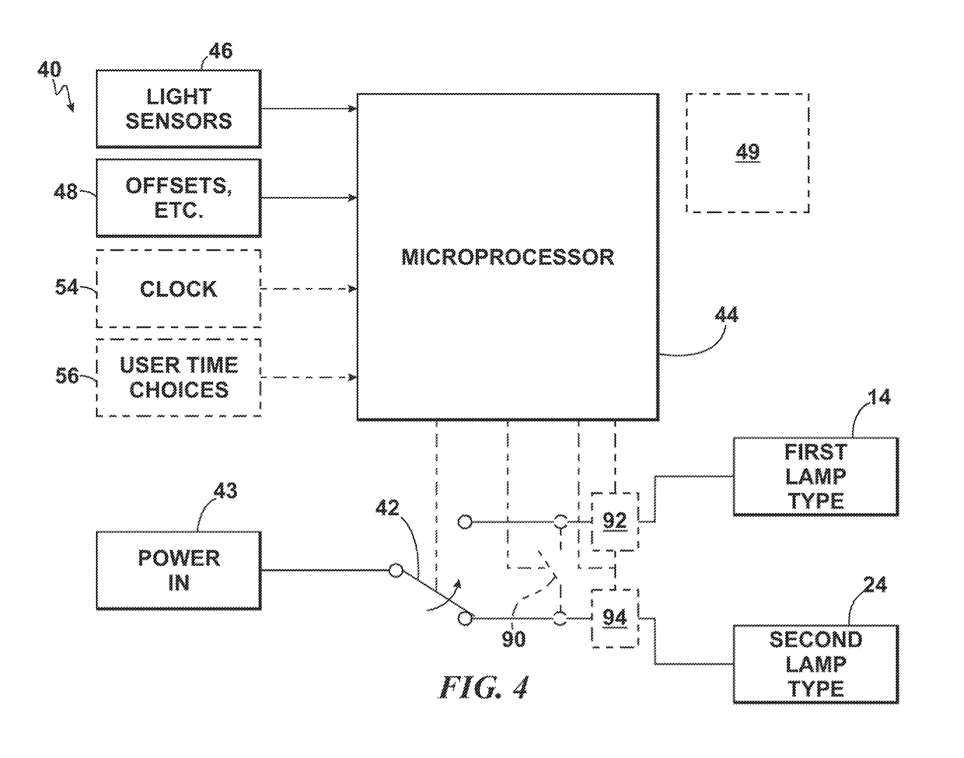

FIG. 4 shows an exemplary electronic control circuit 40 for operating lighting devices according to the present invention. Circuit 40 is preferably contained within lighting device 10 (FIG. 1). Circuit 40 ultimately determines whether an internal switch 42, which is physically located in light socket adapter 20 (FIG. 1A), supplies power to the first type of lamp 14 or to the second type of lamp 24. In more detail, power-in block 43 in FIG. 4 represents power supplied to primary lamp socket 12 in FIG. 1 via switch 18 (e.g. a typical wall or fixture switch) when such switch in a power-on state.

In connection with lighting device 10 of FIG. 1, electronic control circuit 40 could utilize, as an input to a programmed microprocessor 44, a light sensor input 46 provided by light sensor 26 of FIG. 1. Light sensor 26 of FIG. 1 seeks to determine if ambient light from outdoors is present in sufficient amount to qualify as daytime; if the ambient light from outdoors is insufficient to qualify as daytime, then nighttime would be indicated. Preferably, the user provides other inputs 48 for offsets or overriding rules. An offset could be provided, as for instance, to keep the first type of lamp operable for one hour after nighttime is detected. Such offsets could be the same throughout the year, or could vary from season to season, by way of example. An overriding rule could be, for instance, to keep the first type of lamp operable from 8 am to 5 pm even if ambient light from outdoors, from 8 am to 5 pm, dimmed to a point normally indicative of nighttime. This could happen if dark clouds, for instance, caused temporary dimming of sunlight.

According to the light sensor input 46 and other inputs 48 (e.g., offsets), microprocessor 44 causes switch 42 to be connected to the first type lamp 14 during periods of time when the user has determined that melatonin-suppression will not adversely affect the user. Conversely, the microprocessor 44 causes switch 42 to be connected to the second type of lamp 24 during predetermined periods of time when avoidance of melatonin suppression is desired by the user.

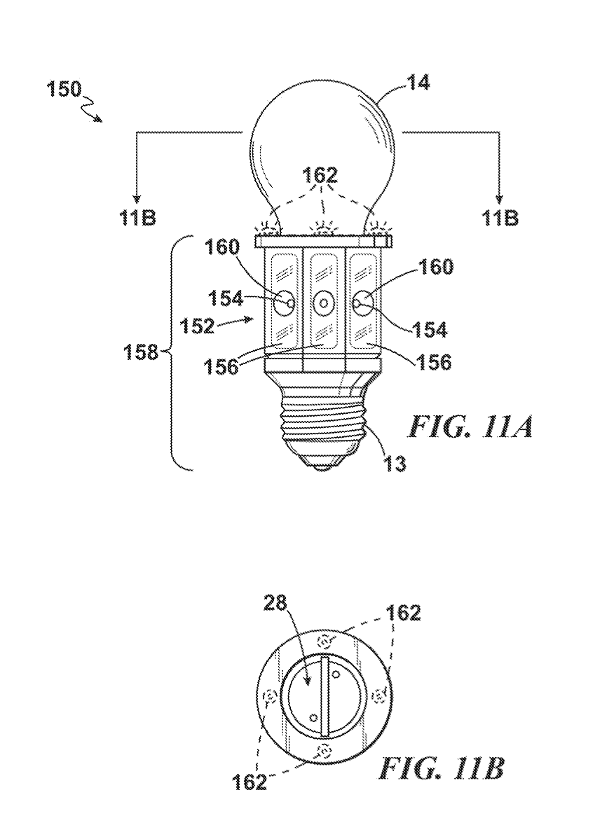

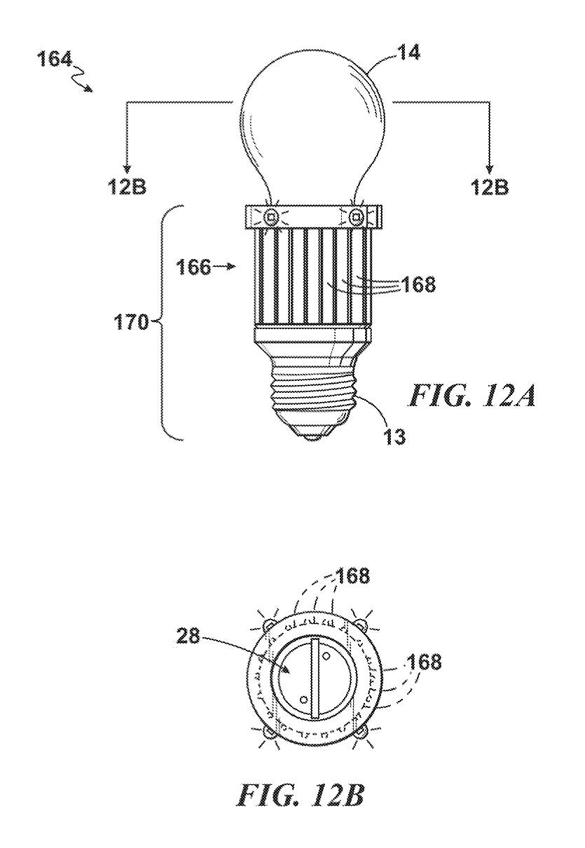

Returning to FIG. 1, it is preferred that the second type of lamp 24 produce at least as much as about 10% of the light produced by the first type of lamp 14. This may require the use of more than the single second type of lamp 24 shown in FIG. 1. Using a 15 Watt compact fluorescent bulb 14 producing 1000 lumen as a typical example, the second type of lamp 24 would preferably emit over 100 lumens of light. This can be easily be accomplished with four red LED sources positioned at ninety degree increments around the light socket adapter 20, each powered to about 1 Watt and each emitting about 30 lumens of light, for 120 lumens total. A more typical embodiment may use four red LED sources powered to about 2 Watts each, emitting about 50 lumens each to achieve 200 lumens total. Such configurations are shown in FIGS. 11A-12B, described below.

Electronic control circuit 40 may include a battery 49 to facilitate programming of the microprocessor without the light socket adapter 20 (FIG. 1A) being inserted into a powered socket (e.g., 12, FIG. 1A).

### Operation in Response to Time of Day or Relative Time

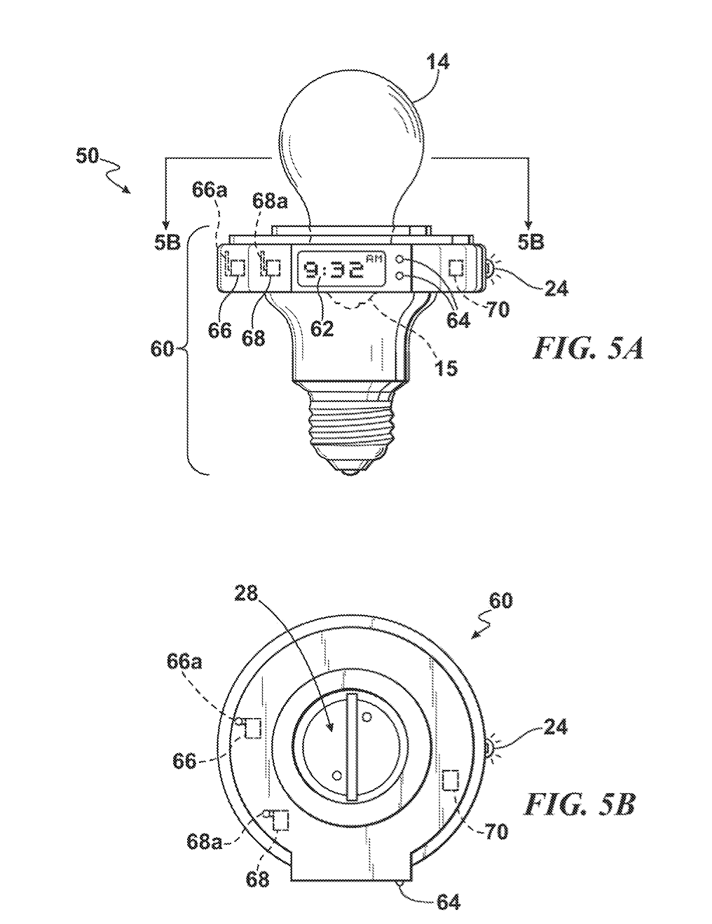

FIGS. 5A and 5B show a lighting device 50 that is responsive to the time of day for causing, in regard to electronic control circuit 40 of FIG. 4, microprocessor 44 to connect either a first type of lamp 14 or a second type of lamp to the power-in block 43, via switch 42. With regard to FIG. 4, an optional clock 54 in the lighting device and an optional input 56 for user time choices provide inputs to microprocessor 44. For instance, microprocessor 44 could be instructed to make the first type of lamp 14 operable only from 6 am to 10 pm and to make the second type of lamp operable from 10 pm to 7 am. Other scenarios than such a 24-hour schedule can be accommodated, such as when users are subject to an 18-hour day, for instance. Further, a relative time schedule could be accommodated, such as making the first type of lamp operable for 6 hours and then making the second type of lamp operable. User input can be via the user time choices 56 input to microprocessor 44 (FIG. 4). Being “operable” does not mean that a lamp provides light; the typical wall or fixture switch 18 of FIG. 1A must also be closed for a lamp to provide light.

In FIG. 5A, a light socket adapter 60 with a first type lamp 14 and a second type lamp 24 may include a time of day display 62 for displaying the time stored in clock 54 of FIG. 4. Adjustment buttons 64 allow the adjustment of time of day of the clock 54 (FIG. 4) and hence of the display 62, as well as allowing the user time choices indicated in block 56 of FIG. 4. These user time choices can be to make the first type of lamp operable from 7 am to 10 pm, for instance.

As an alternative to manually inputting time of day and time choices into the lighting device 50, a user could use optional wireless receiver 66, shown in hidden lines, and an associated antenna 66a, for adjusting the time of day of clock 54 (FIG. 4) and inputting user time choices as per block 56 in FIG. 4. An optional wireless transmitter 68 and associated antenna 68a allows the lighting device 50 to output the time of day of clock 54 (FIG. 4) and user time choices 56 (FIG. 4), so that a user will be able to see on a remote unit (not shown) how the lighting device 50 has been programmed to run. A further alternative way to perform the foregoing functions is to use circuitry 70, shown in hidden lines, for receiving from a remote unit (not shown) programming signals over wires (e.g., the power line “hot”, neutral or ground), and for transmitting to the remote unit the time of day of clock 54 and the user time choices already made.

Although the FIG. 4 implementation of electronic control means with a programmed microprocessor is preferred, other implementations as will be routine to those of ordinary skill in the art include passive or active electronics, software, firmware, or other hardware. Other electronic control means include control via an external processor (computer) signaled wirelessly or through the power line, and control accomplished via a network, such as building-control networks, Internet, or internal private networks.

Manual control could alternatively be used, for instance, in addition to automatic control. Preferably, also, the inventive light socket adapter will include circuitry (not shown) allowing the automatic functions of the adapter to be overridden. It is preferred that this circuitry not require a separate wire to the adapter. The override function could be triggered by a signal frequency riding on the powerline, such as X-10. The override function could alternately be triggered by a wireless signal, such as one using Zigbee protocol. A simple implementation is to have the override triggered by an off-on cycling of the power to the adapter. This allows the adapter to work with any existing light fixture and switch. When the power to the adapter is turned off for a certain range of times, then repowered, the adapter will respond by overriding the special functions and allowing current to freely flow to any light bulb inserted in the adapter's socket.

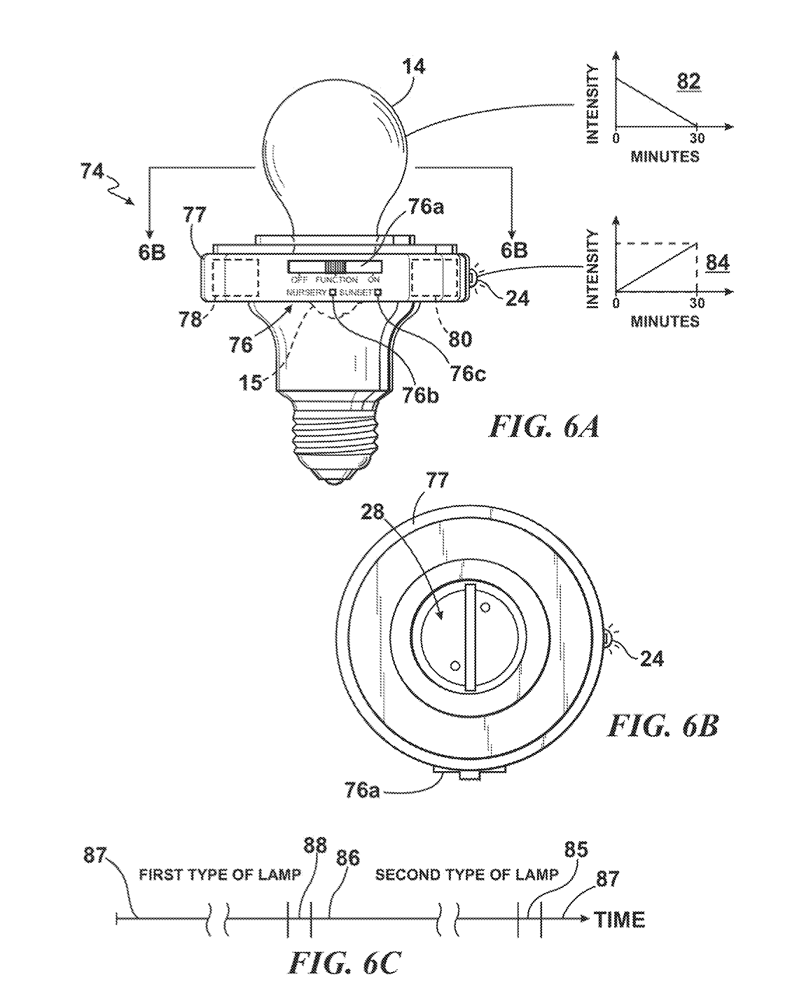

FIG. 6A shows a lighting device 74 with a first type of lamp 14 and a second type of lamp 24. Lighting device 74 includes a switch arrangement 76 on a body portion 77 that allows a user to manually select various functions for operation of the second type of lamp 24. Lighting device 74 may include one or both of light sensor-related features 78, as has been detailed above with respect to lighting device 10 (FIGS. 1A-1B), and time of day-related features 80, as has been detailed above with respect to lighting device 50 (FIGS. 5A-5B).

Switch arrangement 76 for the second type of lamp 24 may include a three-position toggle switch operable to select any of OFF, ON or FUNCTION, explained as follows:
ON: The second type of lamp is always on when typical wall or fixture switch 18 (FIG. 1) is in a power-on state.
OFF: The second type of lamp is always off, regardless of the state of switch 18 (FIG. 1).
FUNCTION: The second type of lamp will follow the behavior required by any of the provided function switches 76a or 76b, for instance. Otherwise, the second type of lamp is preferably always off, regardless of the state of switch 18 (FIG. 1).

The “nursery” function switch 76a allows the behavior of the second type of lamp 24 as already discussed with respect to electronic control circuit 40 of FIG. 4. For instance, switch 42 is controlled in control circuit 40 to either connect power-in block 43 to the first type of lamp 14 or to the second type of lamp 24, depending on predetermined selections responsive to either outdoor ambient light sensed or time of day. The terminology “nursery” function is meant to convey that the second type of lamp 24 can easily provide sufficient light for a mother attending to her baby in the middle of the night. Of course, this can partly arise from providing one or more second type of lamps with sufficient lumen output. But, significantly, this also arises from the fact that the lighting devices of the invention can be interposed between ceiling-wall-mounted or fixture-mounted primary sockets 12 (FIG. 1), and as such are typically at a sufficient height in a room (e.g., above about 1 meter) to allow a mother to have sufficient visual acuity to attend to her baby.

From the foregoing, it will be apparent that the name “nursery” could be replaced with other words connoting the ability for a user to have sufficient visual acuity to perform tasks during a time when avoidance of melatonin-suppression is desired by a user. Further, if the task at hand is very simple, for instance, navigating through a room at night on the way to another room to relieve oneself, the “sufficient visual acuity” can be much less than for a mother attending to a baby. In such a situation, a word such as “night light” might be apt.

### Transition Intervals with Both First and Second Type Lamps On

The “sunset” (or pre-retirement) function switch 76b is an optional function that can be conveniently added to the nursery function or used even if the nursery function is not used. The sunset or pre-retirement function preferably occurs during a transition interval from a period of time in which only the first type of lamp 14 is operable to a period of time in which only the second type of lamp 24 is operable. During the transition period, there is a preferably gradual transitioning of light from the first type of lamp 14 to the second type of lamp 24, “gradual” being defined below.

Preferably, as shown in FIG. 6A in the light intensity-versus-minutes curve 82, the first type of lamp is gradually dimmed from its normal output (e.g., its output just before the onset of the sunset mode) to zero output during a period of time. Such period of time may be above about 10 minutes, and more preferably about 30 minutes to about 60 minutes, although longer times are possible. By way of example, the transition interval could start from a predetermined time of day chosen by the user (e.g., 1 hour before they retire for the evening), or it could be timed to coincide with the natural sunset. Preferably, during the same period of time as the first type of lamp is being dimmed, the light output from the second type of lamp, as shown in the light intensity-versus-minutes curve 84, gradually increases in light intensity from zero to a predetermined value (e.g., a normal output value). However, the onset and conclusion of the change-in-light-intensity behaviors of the first and second types of lamp need not be coextensive, although it is preferred that some part (e.g., 50% or 75%) of these respective behaviors of the first and second types of lamps coincide with each other. The resulting mixture of light gradually becomes less suppressive of melatonin production in a user, so that the body can start producing melatonin in preparation for sleep, while at the same time providing adequate light for a user to conduct many different types of tasks. Further due to the overlapping of the foregoing respective behaviors of the first and second lamps, the increasing light from the second type of lamp partially or fully or even more than fully compensates the decreasing light from the first type of lamp. This is, of course, requires the selection of light intensity output of the first and second types of lamps to achieve the desired level of compensation.

By “gradual” change in light output intensity is meant herein that the light transitioning occurs in a sufficiently smooth way as to minimize light-intensity level perturbations that would cause annoyance to a typical user. Determination of such a smooth transitioning will be apparent to persons of ordinary skill in the art.

With respect to FIG. 6C, if desired, a similar transition interval 85 with changes in light intensity similar to that in the foregoing “sunset” function can occur as well when switching from a period of time 86 when only the second type of lamp is operable to a period of time 87 in which only the first type of lamp is operable. In such case, the transition interval may be considerably shorter (e.g., one second) so long as the transition is gradual. A transition interval 88 similar to the sunset function interval, but shorter, can replace the sunset function when switching from a period of time 87 when only the first type of lamp is operable to a period of time 86 In which only the second type of lamp is operable.

To implement the sunset function, electronic control circuit 40 of FIG. 4 may include an additional switch 90 that allows both the first lamp type 14 and the second lamp type 24 to simultaneously provide light. Variable-intensity control circuitry 92 and 94 can be used to implement to change-of-intensity behavior of the first and second types of lamps shown at 82 and 84 in FIG. 6A. Suitable variable-intensity control circuitry is known in the art.

### Other Features

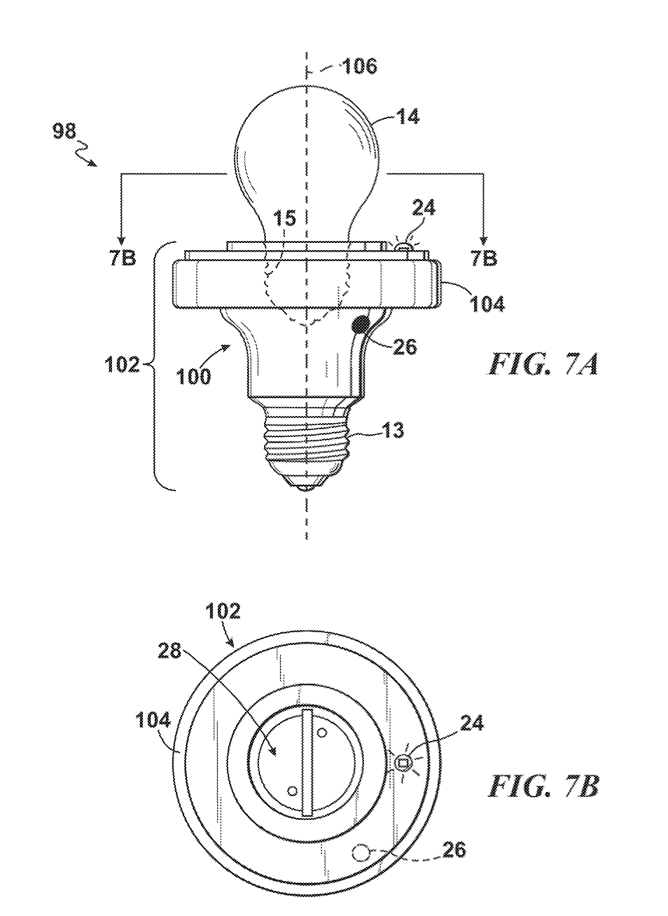

FIGS. 7A and 7B show a lighting device 98 in which body portion 100 of light socket adapter 102 includes a shading element 104. Shading element 104 affects the light striking any of the light sensors, such as sensor 26. The shading element may also have other purposes, such as being part of enclosure for light socket adapter 102, being part of a light-emitting device or of transformational or transportational optics, or being part of the socket for first type of lamp base 15. Preferably, the shading element 104 is configured to at least partially block light from the first type of lamp 14 from directly illuminating the light sensors. Shading element 104 may also be positioned to at least partially block light from the second type of lamp 24 from the light sensors. The shading element 104 may block the light from a light source (e.g., 14 or 24) entirely, or only partially, or only block part of the spectrum of a light source. The shading element 104 could be substantially circular, tubular or disc shaped perpendicular to main axis 106 of the base 13.

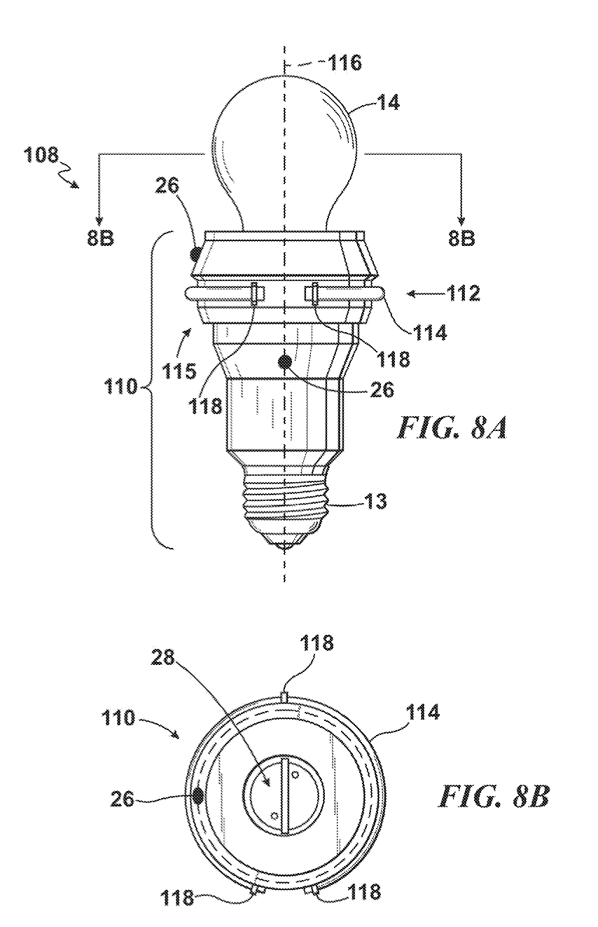

FIGS. 8A and 8B show a lighting device 108 having a light socket adapter 110 that includes a second type of lamp 112 having a light-emitting section 114 in the shape of a ring looping around body portion 115. The ring shape may be annular or may deviate from an annular shape provided that it follows a loop pattern. Light-emitting section 114 preferably forms a loop around a first axis 116 extending through the primary socket (e.g., 12, FIG. 1A) and through body portion 115. The light-emitting section 114 may be mounted to the body portion 115 with C-shaped clips 118 whose open ends are received within respective apertures (not shown) in body portion 115, by way of example.

The second type of lamp may comprise a fluorescent, cold cathode or neon light source, by way of example, mounted in a loop pattern about the surface (e.g., circumference) of body portion 115. The electrodes (not shown) for the light-emitting section are located at the ends of the light-emitting section, near the vicinity of the clips 118 in FIG. 8A. Preferably, the light-emitting section 114 of the second type of lamp 112 surrounds the body portion 115 for at least about 270 degrees, although lesser coverage such as 180 degrees is also useful. Such a relatively enlarged light-emitting section 114, compared to typical LEDs, beneficially results is less glare to the user. Glare is the user's perception of high brightness from a light source, and has a negative connotation. Very high brightness can hurt the eyes of a user. Glare can cause annoyance, discomfort, loss in visual performance and acuity, and eye fatigue. Additionally, by having the light-emitting section 114 loop around the body portion 115, the lamp become less direction specific in its required location. That is, less attention needs to be made to the direction of the second type of lamp 112 when installing lighting device 108, since light from lamp 112 is directed over a wide area.

FIG. 8A also shows a plurality of light sensors 26, which are mounted on different planes and points in different angles. Having a plurality of light sensors can improve the accuracy and sensitivity of the inventive light adapter with respect to sensing changes in the environment and light levels. When multiple sensors are used, they are preferentially mounted on separate planes or facing different directions. In this way, temporary local excursions in the ambient light levels (e.g., from outdoor light) have a lessened effect of causing an unintended response from the adapter. As an example, an adapter could be used in a bedroom with a first sensor positioned so that it detects light reflected off of the South wall and a second sensor positioned so that it detects light reflected off of the North wall. On a dark night, a passing car could shine headlights onto the South wall, which might normally trigger the adapter to switch to day mode. However, the second sensor does not see the light from the passing car and logic within the adapter determines that it is not yet morning.

Multiple sensors can also work in harmony to gain better coverage of a room. A first sensor pointed to the East might detect the bright sky at sunrise and a second sensor pointed to the West might detect the bright sky at sunset. A plurality of sensors allows light detection as daylight enters in through alternate windows throughout the day.

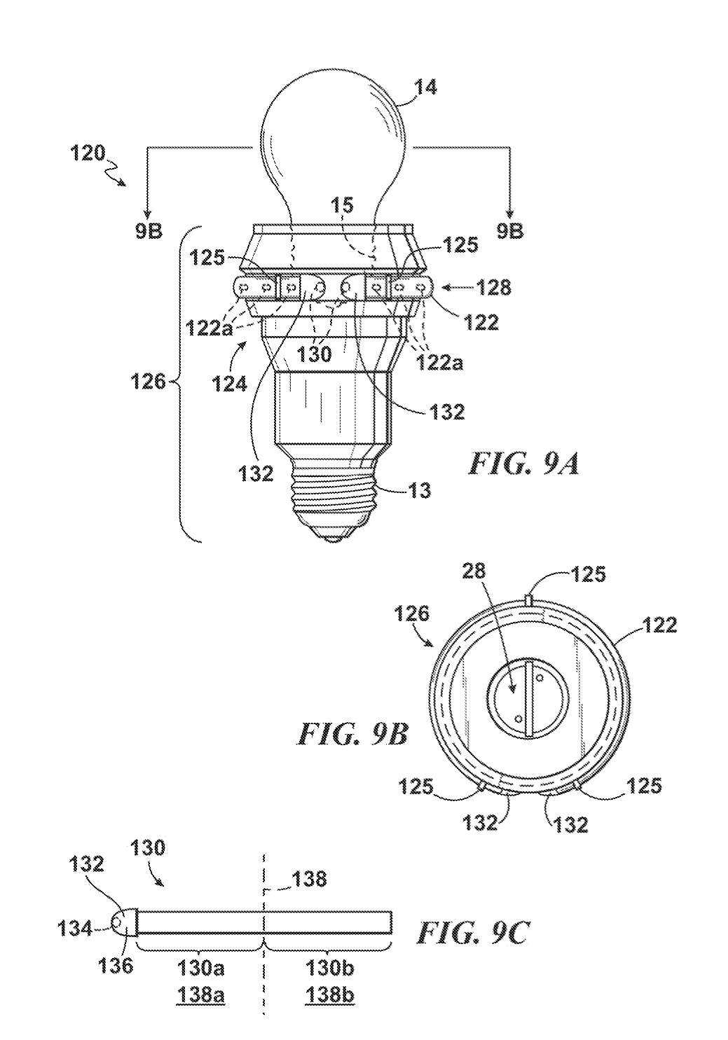

FIGS. 9A-9B show a lighting device 120 that is similar to lighting device 108 insofar as including a light-emitting section 122 in the shape of a ring looping around a body portion 124 of a light socket adapter 126. However, light-emitting section 122 of the second type of lamp 128 is a fiberoptic light-emitting section, which may have light-extraction means 122a in the exemplary form of white paint on a radially inner surface, or other light-extraction means as will be apparent to persons of ordinary skill in the art. The light-emitting section may be mounted to the body portion 124 with C-shaped clips 125 whose open ends are received within respective apertures (not shown) in body portion 124, by way of example.

The second type of lamp 128 may include one or more LEDs 130, by way of example, together with additional optical elements 132 to transform and transport the light to the fiberoptic light-emitting section 122. The transformation could be any combination of angular, spatial, uniformity (brightness) or spectral content. A typical transformation would be of the angular distribution of the light by using beam forming optics, typically solid TIR beam formers or reflective surfaces. The transformation could also be of the spectral content, which could be accomplished with a spectrally selective absorbing medium such as a colored filter; it could also be a spectrally selective reflective surface such as a dichroic mirror.

The transformation could also be of the brightness of the light. Typically, this would mean increasing the area over which the light is emitted to reduce objectionable high brightness glare that can cause discomfort to the eye. One way to do a brightness transformation is to use beam-forming optics, as described above. Another way is to direct the light into a fiberoptic light pipe that includes light-extraction means (e.g., 122a, FIG. 9A). The light-extraction means would cover a larger area than the original light-producing device(s), e.g., LEDs 134, so as reduce glare from such light-producing devices. The light-extraction means may include patterned scattering elements, reflective elements, or patterns creating TIR/Fresnel extraction surfaces, by way of example.

The light may also be transported from the light-emitting device to a different location in the adapter. The thickness of a beam-forming element is a transported distance. Another embodiment uses a fiberoptic light pipe that traces along some part of the adapter. The light pipe emits some of the light out the end of the pipe or along the length of the pipe or any combination of the two. FIG. 9C shows a fiberoptic light pipe 130 and associated light source 132 comprising an LED 134 and optic 136. Fiberoptic light pipe 130 has a non-side lighting emitting section 130a shown within periphery 138 of body portion 124 (FIG. 9A), as denoted at 138a. Light pipe 130 has a contiguous side-light emitting section 130b shown outside the periphery 138 of body portion 124, as denoted at 138b.

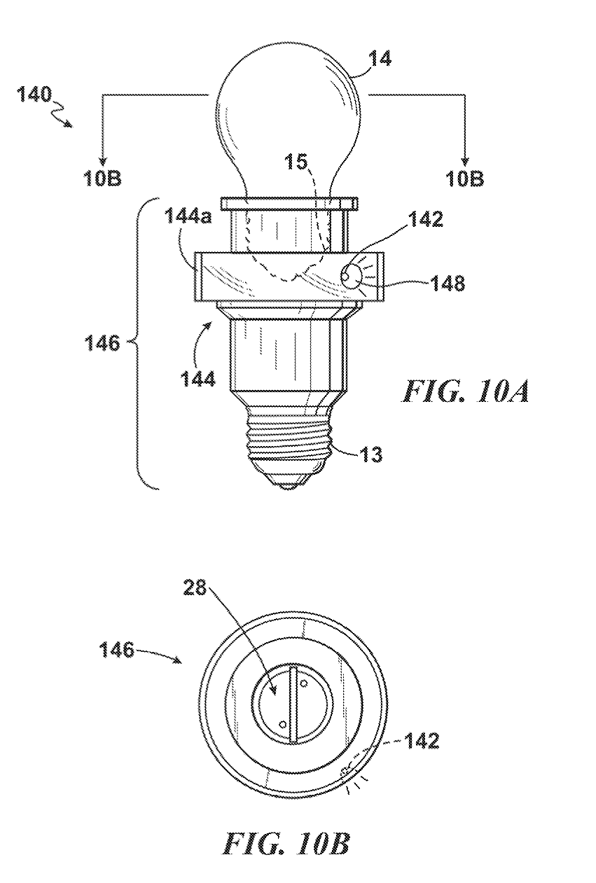

FIGS. 10A and 10B a lighting device 140 having a second type of lamp 142 located within body portion 144 of light socket adapter 146, with the adapter having means to allow the light to exit from the body portion. Such means could be a hole in the adapter. Such means could also be a beam-transforming optic that both adjusts the angular distribution of the light and allows the light to exit the adapter. Such beam-transforming means may have multiple purposes, including adjusting angular distribution, spectral distribution, brightness distribution or spatial distribution at the same time it is enabling at least a portion of the light to escape the adapter.

The outer periphery 144a of the body portion 144 may be made of transparent material so that the second type of lamp 142 can be sealed within the transparent material and still shine light outwardly. Such an arrangement helps to protect the second type of lamp 142 from environmental contaminants such as dust, humidity or insects.

FIGS. 11A and 11B show a lighting device 150 that can have a narrow body portion (e.g., less than 2.5 cm in diameter) by incorporating the second type of lamp 154 within the body portion. A series of planes or facets 156, as shown, or indents or protrusions in the body portion 152 give the user an extra ability to grip and turn the adapter 158. Collectively, the plurality of grip-improving elements 156 forms a grip surface.

The plurality of grip-improving planes or facets 156 may have the second types of lamps 154 and preferably beam-transforming optics 160 for coupling the light from the second type of lamp 154 to outside the adapter 158. This can be accomplished through embedding, co-molding, or thinning a section of the body portion. When the second type of lamps 154 are made of electroluminescent material or organic LEDs, over half of the surface of the grip-improving planes or facets 156 could be formed of, or covered by the second type of lamp.

If additional light from the second type of lamp is desired, then lamps 162 could be added to the top plane of the body portion 152, for example.

FIGS. 12A and 12B show a lighting device 164 that may also have a small diameter body portion 166 as with lighting device 150 of FIGS. 11A and 11B. The body portion 166 is shown a plurality of indents 168 around its circumference. These indents 168 could be linear as shown, or be rectangular, or have other geometric shapes. Preferably, these indents are configured to also improve the user's ability to grip the light socket adapter 170.

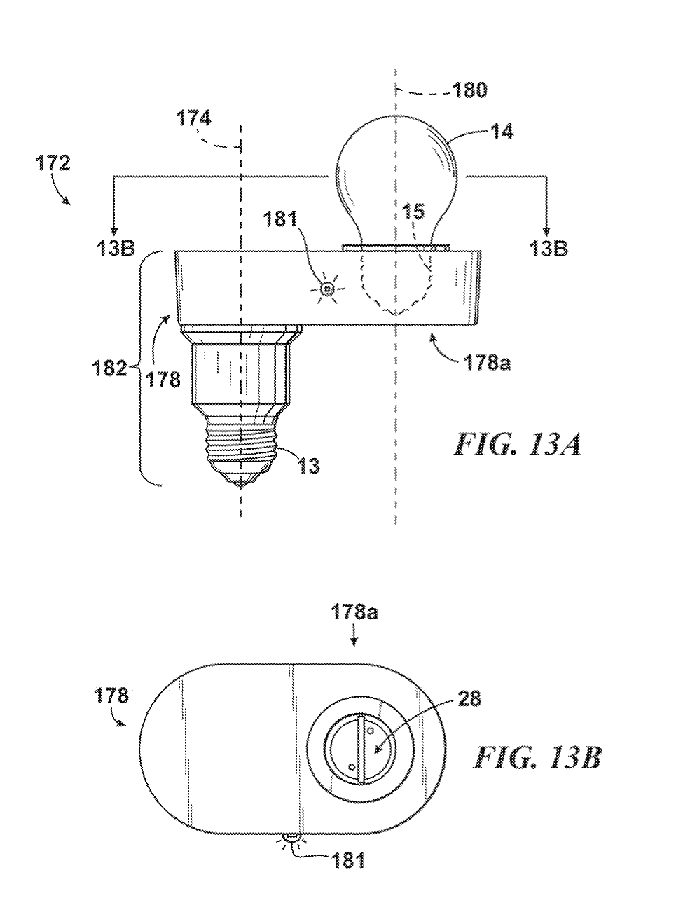

FIGS. 13A and 13B show a lighting device 172 in which the first type of socket 28 (FIG. 13B) and main adapter base 13 need not be located on the same axis. Thus, a first axis 174 extends through a main adapter base 13 for insertion into the primary socket (e.g., 12, FIG. 1A), and body portion 178 of lighting device 172 has a transverse extension 178a extending from first axis 174. By transverse is meant being crosswise, not necessarily at a 90-degree angle. A second axis 180 passes through a main axis of the first type of lamp 14. The first and second axes 174 and 180 are parallel to each other within about 40 degrees. A second type of lamp 181 may be provided on body portion 178.

In FIGS. 13A and 13B, offsetting the first type of socket 28 from the main adapter base 13 allows for a shorter adapter. It also may allow the sensor or light emitting device to be located along the axis of the base, which beneficially may improve the efficiency of the light socket adapter 182.

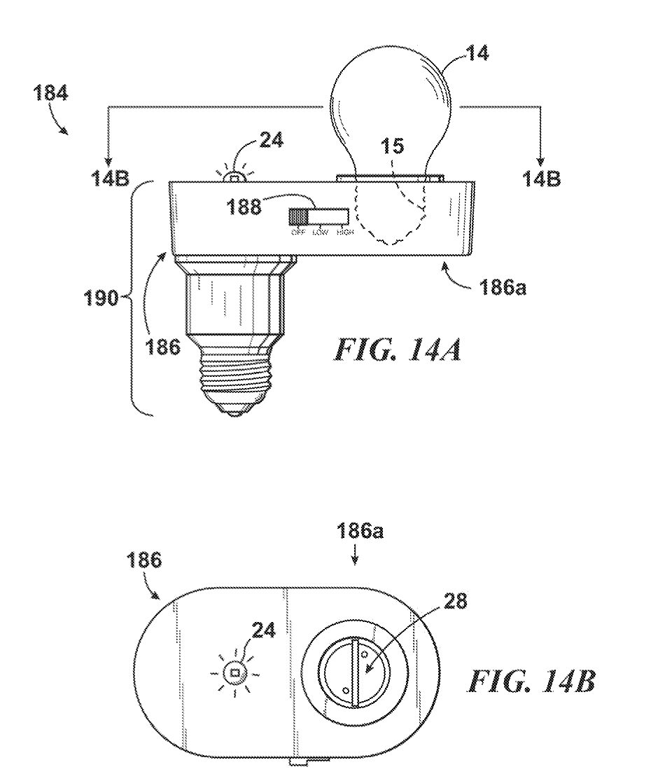

FIGS. 14A and 14B show a lighting device 184, which, like lighting device 172 of FIGS. 13A and 13B, has a body portion 186 with a transverse extension 186a. A second type of lamp 24 is mounted on body portion 186. A user-operated switch 188 allows a user to choose between different light levels to be emitted from the second type of lamp 24, preferably in a continuous manner. Since the light socket adapter 190 is intended to be interposed between a first type of lamp 14 and a wall-, ceiling- or fixture-mounted primary base (e.g., 12, FIG. 1A), it the second type of lamp will be typically mounted more than one meter above the ground and typically above an area to be illuminated. This makes the second type of lamp far more versatile than typical night lights that are usually located below one meter, near an electrical outlet.

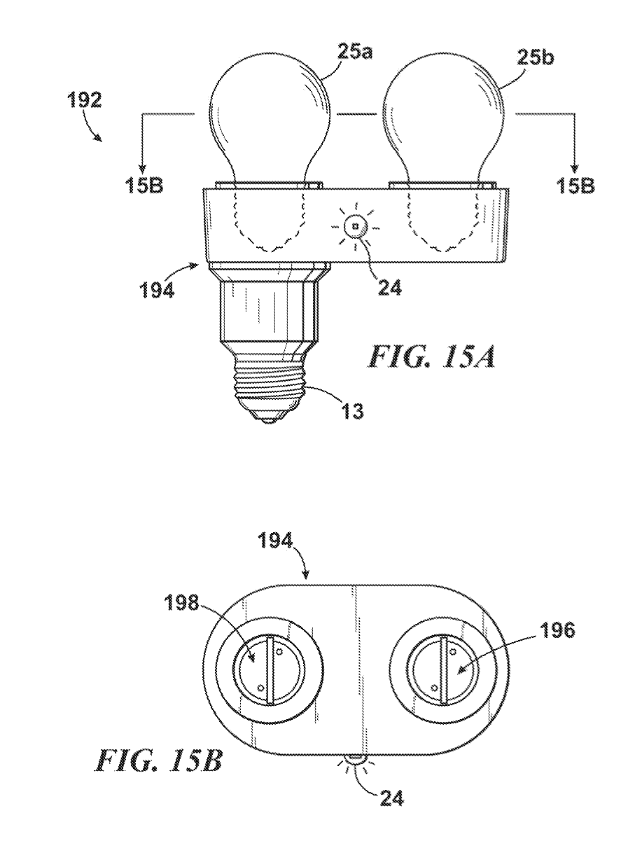

FIGS. 15A and 15B show a lighting device 192 having a body portion 194 configured like body portion 178 of lighting device 172 of FIGS. 13A and 13B, except for the following: Two sockets 195 and 196 are provided for receiving a first type lamp 25a and a second type lamp 25b, respectively, or vice versa. Sockets 195 and 196 and their associated lamps can be interchanged in position. The second type of lamp 25a or 25b beneficially can be a lamp that is more easily replaceable than rigidly mounted second type of lamp 24.

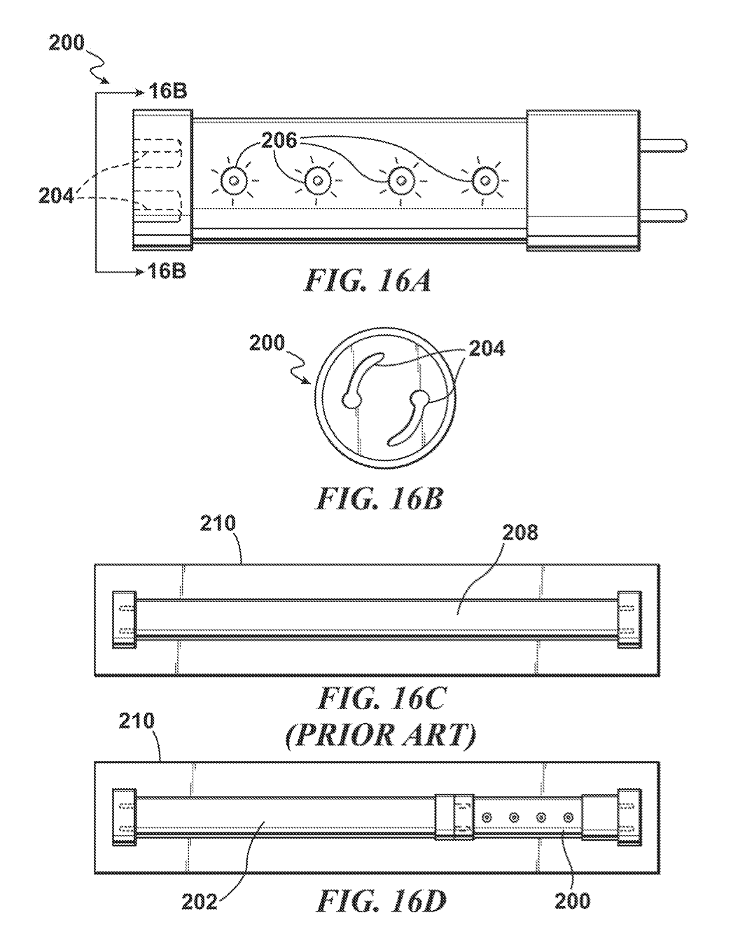

FIG. 16A shows a light socket adapter 200 in preferably tubular shape, which fluorescent lamp 202 of FIG. 16D. FIG. 16B best shows two-pin socket 204 for a fluorescent lamp, for instance. Light socket adapter 200 has several second type of lamps 206, which conform to the above descriptions of second types of lamps.

The intention of light socket adapter 200 is to replace the tubular fluorescent lamp 208 of fixture 210 of FIG. 16C with the light socket adapter 200 and a shorter fluorescent lamp 202.

Other features of the inventive lighting devices described above may be applied to the light socket adapter 200 of FIGS. 16A-16B and 16D, such as the inclusion of light sensors (e.g., 26 in FIG. 8A).

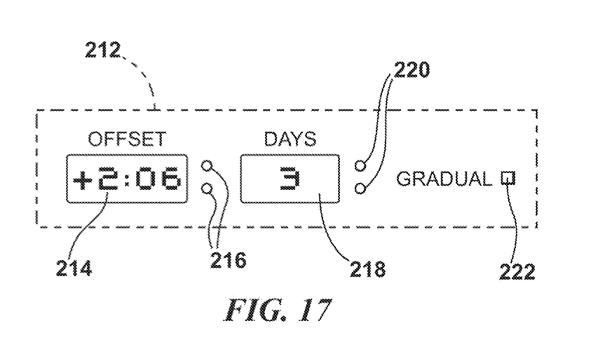

FIG. 17 shows a user interface 212 located on the inventive light socket adapter or at a remote location which has the ability to communicate with the light socket adapter. The user interface 212 contains an offset feature 214 with controls 216. Using offset controls 216, the user can set a preferably temporary positive or negative offset in time to an otherwise default arrangement for transitioning between the first type of lamp being exclusively operable and the second type being exclusively operable. Default arrangements are described above in connection with FIGS. 1A-1B and 5A-5B, for instance. This feature can be utilized when the user desires the transition in lighting to occur a few hours earlier than usual, for instance, to wake up for a big presentation. Similarly, the offset feature can be set to cause a transition in lighting a few hours later than usual, for instance, to accommodate the user staying up late to watch a favorite local sports team or special television program.

The user interface 212 may also contain a day indicator 218 with controls 220 which can set the number of days that the user desires the offset feature to function before it resets to the usual programming. The user interface 212 further contains a push button 222 which allows the offset feature to take effect gradually over the number of days indicated. As an example, consider the jetlag-weary traveler who is planning to visit a country 6 hours ahead in time. The user can set the offset feature 214 to +6 hours using controls 216, and the day indicator 218 to 3 days using controls 220. Instead of instantly reverting to the 6-hour time offset, the user may opt for a gradual transition by pressing push button 222, which will divide up the 6 hours over 3 days, by way of example, causing a gradual incremental change of 2 hours per day.

It is intended that features of one inventive lighting device can be applied to other inventive lighting devices, unless the result would not work. Thus, for instance, in the use of multiple second types of lamp 154 and 162 in FIGS. 11A and 11B can be applied to any of the other lighting devices described herein.

The various light socket adapters of the lighting devices of the invention will typically be made of plastic, with the first type of socket for accommodating a first type of lamp base (e.g., 15, FIG. 1A) and the main adapter base (e.g., 13, FIG. 1A) being molded into or inserted into the plastic. The plastic forms a type of envelope to house any internal circuitry or wiring.

The implementation of the electronic control circuit 40 of FIG. 4, or of any of the other alternatives disclosed herein, is within the routine skill of a person of ordinary skill in the art based on the present specification.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

What is claimed is:

1. A lighting device operable to supply temporally appropriate light to a user, comprising:
a) a light socket adapter for interposing between a primary socket and a first type of lamp;
b) said primary socket being connected to a supply of electrical power when an associated power switch is in a power-on state and being disconnected from the supply of electrical power when the associated power switch is in a power-off state;
c) the light socket adapter including a body portion; at least one of a second type of lamp being mounted on said body portion; and said body portion having a first type of socket for receiving and supplying power to said first type of lamp;
d) the first type of lamp supplying light that includes wavelengths below 530 nm that are suppressive of melatonin production in a user viewing said light, and the second type of lamp supplying light that is substantially all above 530 nm so as to avoid suppressing melatonin production in a user viewing the light; and
e) the light socket adapter having at least one mode of operation in which automatic means causes—
i) only the first type of lamp to be operable during predetermined periods of time when the user determines that melatonin-suppression will not adversely affect the user and only when the power switch is in a power-on state, and
ii) only the second type of lamp to be operable during predetermined periods of time when avoidance of melatonin suppression is desired by the user and only when the power switch is in a power-on state.

2. The lighting device of claim 1, wherein said one mode of operation includes the automatic means causing, during a transition interval—
a) whichever type of lamp is operating to dim from a predetermined level to off in a gradual manner over a first predetermined period of time of approximately one second; and
b) the other type of lamp to increase in intensity from off to a predetermined level in a gradual manner over a second predetermined period of time of at least approximately one second;
c) the foregoing predetermined periods of time overlapping each other for more than 50 percent of whichever predetermined period of time is longest.

3. The lighting device of claim 2, wherein the first and second predetermined periods of time each exceed about 10 minutes.

4. The lighting device of claim 2, wherein the first and second predetermined periods of time each exceed about 30 minutes.

5. The lighting device of claim 1, wherein the automatic means comprises electronic control means in the light socket adapter, responsive to the time of day contained in a clock in the body portion, to allow a power switch for the device to cause power to be delivered to any of the first type of lamp or to any of the second type of lamp.

6. The lighting device of claim 2, wherein means are provided for adjusting the time of said clock.

7. The lighting device of claim 6, wherein remote means are provided for adjusting said clock.

8. The lighting device of claim 6, wherein:
a) the body portion includes a display of time of said clock; and
b) user-manipulated means are provided for adjusting the time of said clock.

9. The lighting device of claim 1, wherein the body portion includes a user-manipulated switch having the capability of selecting:
a) the second type of lamp being always off;
b) the second type of lamp being always on; or
c) the second type of lamp being under the control of said electronic control means.

10. The lighting device of claim 1, wherein the automatic means comprises electronic control means in the light socket adapter, responsive to a determination of daytime or nighttime from at least one light sensor, to allow a power switch for the device to cause power to be delivered to any of the first type of lamp or to any of second type of lamp.

11. The lighting device claim 10, wherein the at least one sensor comprises a plurality of sensors mounted on respectively separate planes or respectively facing different directions.

12. The lighting device of claim 10, wherein the body portion includes a user-manipulated switch having the capability of selecting:
a) the second type of lamp being always off;
b) the second type of lamp being always on; or
c) the second type of lamp being under the control of said electronic control means.

13. The lighting device of claim 1, wherein the automatic means is responsive to the users inputs on a user interface for providing temporary offsets in time for transitioning between the first type of lamp being exclusively operable and the second type being exclusively operable

14. The lighting device of claim 13, wherein the user inputs include a selection of the number of days for the offsets to be effective.

15. The lighting device of claim 14, wherein the user inputs include a selection of whether to apply the offsets gradually over time based on the selection of the number of days.

16. The lighting device of claim 1, wherein a second type of lamp has a light-emitting section in the shape of a ring that surrounds a part of the body portion for more than 180 degrees.

17. The lighting device of claim 1, wherein a second type of lamp has a light-emitting section in the shape of a ring that surrounds a part of the body portion for more than 270 degrees.

18. The lighting device of claim 16, wherein:
a) the lighting device has a first axis extending through said body portion and through said primary socket, when mounted thereto; and
b) the ring loops around the first axis.

19. The lighting device of claim 16, wherein the light-emitting section comprises a vitreous envelope of a gas discharge lamp.

20. The lighting device of claim 16, wherein the light-emitting section comprises a fiberoptic light pipe.

21. The lighting device of claim 20, wherein the second type of lamp comprises an LED.

22. The lighting device of claim 21, wherein the second type of lamp comprises an optic for reducing the angles of light from the LED that are directed to the fiberoptic light pipe.

23. The lighting device of claim 1, wherein the second type of lamp comprises an LED recessed below an outer surface of the body portion.

24. The lighting device of claim 23, wherein the second type of lamp further comprises an optic for transforming light from the LED that are directed to the fiberoptic light pipe.

25. The lighting device of claim 23, wherein the LED is protected by an optically transmissive cover.

26. The lighting device of claim 1, wherein:
a) the body portion has an externally-oriented surface extending 360 degrees about an axis for gripping by a user;
b) cross-sections of said surface orthogonal to said axis being configured non-circularly so as to enhance gripping ability by a user.

27. The lighting device of 26, wherein said externally-oriented surface comprises a series of facets extending 360 degrees about said axis.

28. The lighting device of claim 26, wherein said externally-oriented surface comprises a plurality of indents extending along said axis; said plurality of indents extending serially 360 degrees about said axis.

29. The lighting device of claim 26, wherein said body portion includes at least one LED recessed below said externally-oriented surface.

30. The lighting device of claim 29, wherein the LED is protected by an optically transmissive cover forming part of the body portion.

31. The lighting device of claim 29, wherein at least one LED is mounted in the body portion different from said externally-oriented surface.

32. The lighting device of claim 10, wherein the body portion includes a shading element to block straight-path light transmission from any of the first type of lamps and any of the second type of lamps to said at least one light sensor.

33. The lighting device of claim 32, wherein:
a) the lighting device has a first axis extending through said body portion and through said primary socket, when mounted thereto; and
b) the shading element is interposed, along said first axis, between each of the first type of lamp and each of the second type of lamp and said at least one light sensor.

34. The lighting device of claim 33, wherein the shading element comprises a part of the body portion that is enlarged about the first axis.

35. The lighting device of claim 1, wherein:
a) the lighting device has a first axis extending through a main axis of a main adapter base for insertion into said primary socket and through a first socket; and
b) the body portion having a transverse extension from the first axis; the transverse extension having a second socket;
c) one of the first and second sockets being constructed as a first type of socket for a first type of lamp and the other of the first and second sockets being constructed as a socket for a second type of lamp.

36. The lighting device of claim 35, wherein:
a) the first type of socket on the transverse extension has a second axis passing through a main axis of the first type of lamp; and
b) the first and second axes being parallel to each other within approximately 40 degrees.

37. The lighting device of claim 1, wherein:
a) the lighting device has a first axis extending through a main axis of a main adapter base for insertion into said primary socket; and
b) the body portion having a transverse extension from the first axis; the transverse extension having said first type of socket for receiving one of the first type of lamp.

38. The lighting device of claim 37, wherein:
a) the first type of socket has a second axis passing through a main axis of the first type of lamp; and
b) the first and second axes being parallel to each other within approximately 40 degrees.

39. The lighting device of claim 1, wherein the body portion includes a switch for adjusting the level of intensity of each of the second type of lamp.

40. The lighting device of claim 39, wherein the switch is constructed in such a manner as to allow adjustment of said intensity in a continuous manner.

41. The lighting device of claim 1, wherein:
a) the lighting device has a first axis extending through said body portion and through a main adapter base for insertion into said primary socket; and
b) the first type of lamp is a tubular fluorescent lamp;
c) the body portion has a shape approximating a tubular length of said fluorescent lamp; and
d) the first axis extends through a main axis of the first type of lamp and the body portion.
